(19) United States
(12) Patent Application Publication
(10) Pub. No.: US 2025/0127679 A1
(43) Pub. Date: Apr. 24, 2025

(54) Leg Massager

(71) Applicant: Yuanhao FENG, Dongguan Guangdong (CN)

(72) Inventor: Yuanhao FENG, Dongguan Guangdong (CN)

(73) Assignee: Reestar International Limited, Kowloon (HK)

(21) Appl. No.: 18/381,553

(22) Filed: Oct. 18, 2023

(51) Int. Cl. A61H 9/00

(52) U.S. Cl. CPC A61H 9/0092; A61H 2201/164; A61H 2201/165; A61H 2201/5002; A61H 2205/106; A61H 2205/108; A61H 2205/12

(57) ABSTRACT

A massager useful for massaging a user's legs is disclosed. The leg massager comprises a flexible foot enclosure having foot internal volume, a flexible calf enclosure having a calf internal volume, a flexible knee portion, a flexible thigh enclosure having a thigh internal volume and at least one zipper. The upper end of the foot enclosure connects the lower end of the calf enclosure. The upper end of the calf enclosure connects the lower end of the knee portion. The upper end of the knee portion connects the lower end of the thigh enclosure. At least one zipper adapts and runs along the leg massager from the foot enclosure to the thigh enclosure through the calf enclosure and the knee portion.

### FIELD OF THE INVENTION

The invention relates to the field of massage equipment, in particular to a massager for the user's legs.

### BACKGROUND OF THE INVENTION

The field of the invention is massaging device, and the invention relates more specifically to a device useful for massaging the user's legs, particularly the foot, calf and thigh muscles. The benefit and comfort of a leg massager is widely recognized. Unfortunately, the wearing of prior art leg massagers are difficult, time consuming and inconvenient.

U.S. Pat. No. 4,989,589 disclosed a device for massaging extremities such as legs. The device comprises a plurality of mutually and annularly connected jacket bags in mutual fluid communication through borders therebetween. Unfortunately, the device is difficult to wear and fit the size of the user's legs.

U.S. Patent Application Pub. No. 2022/0387249 disclosed a therapeutic compression apparatus system and methods of use. It includes at least one therapeutic compression apparatus having at least one elastic sock or sleeve integral and connected to at least one wrap having at least one bladder and a universal inflation port to connect to an inflation means to the at least one bladder. However, the structure of the device is complicated, heavy and difficult to wear.

U.S. Patent Application Pub. Nos. 2023/0270621, 2023/0270622 and 2023/0310256 disclosed compression devices wearable by a user applies compression on a left lower limb and a right lower limb. They employ hook and loop fasteners to secure the devices on a user's limb. Unfortunately, using hook and loop fasteners is noisy and requires a great user's force to unfasten it when putting off the device from a user's limb.

There is therefore a need for a leg massaging device which can be easily put on and off a user's leg in a quiet, fast, easy and comfortable manner.

### BRIEF SUMMARY OF THE INVENTION

The invention is for a massager useful for massaging the user's legs. The leg massager comprises: a flexible foot enclosure, having a lower end and an upper end, comprising a foot internal volume; a flexible calf enclosure, having a lower end and an upper end, comprising a calf internal volume; a flexible knee portion, having a lower end and an upper end; a flexible thigh enclosure, having a lower end and an upper end, comprising a thigh internal volume.

The leg massager also comprises at least one zipper.

The upper end of the foot enclosure connects the lower end of the calf enclosure. The upper end of the calf enclosure connects the lower end of the knee portion. The upper end of the knee portion connects the lower end of the thigh enclosure.

At least one zipper adapts and runs along the leg massager from the foot enclosure to the thigh enclosure through the calf enclosure and the knee portion. Different locations of the zippers accommodate different sizes of the user's leg.

The leg massager further comprises a means for providing pressurized fluid; a first fluid passage for supplying and removing fluid between the means for providing pressurized fluid and the foot internal volume; a second fluid passage for supplying and removing fluid between the means for providing pressurized fluid and the calf internal volume; a third fluid passage for supplying and removing fluid between the means for providing pressurized fluid and the thigh internal volume.

The leg massager further comprises: a first valve, connected between the means for providing pressurized fluid and the first fluid passage for opening and closing the throw of the fluid into the foot internal volume; a second valve, connected between the means for providing pressurized fluid and the second fluid passage for opening and closing the throw of the fluid into the calf internal volume; a third valve, connected between the means for providing pressurized fluid and the third fluid passage for opening and closing the throw of the fluid into the thigh internal volume.

The leg massager further comprises a controller configured to control the open and close of the first valve, second valve and third valve.

The user can use the leg massager easily by opening the at least one zipper down to the foot enclosure, inserting a leg into the leg massager, closing the at least one zipper along the leg massager from the foot enclosure to the thigh enclosure through the calf enclosure and the knee portion, using the controller configured to control the means for providing pressurized fluid, the first valve, the second valve and the third valve such that compression forces are applied on the user's foot, calf and thigh muscles by flexible foot enclosure, flexible calf enclosure and flexible thigh enclosure respectively.

The leg massager does not employ the use of hook and loop fasteners which are noisy and require great user's force to unfasten it when putting off the device from the user's leg.

### BRIEF DESCRIPTION OF THE SEVERAL VIEWS OF THE DRAWINGS

The accompanying drawings illustrate one or more embodiments of the invention and, together with the written description, serve to explain the principles of the invention, and wherein:

FIG. 1 is a front elevation view of the leg massager of the present invention;

FIG. 2 is a front elevation view of the flexible foot enclosure;

FIG. 3 is a front elevation view of the flexible calf enclosure;

FIG. 4 is a front elevation view of the flexible knee portion;

FIG. 5 is a front elevation view of the flexible thigh enclosure;

FIG. 6 is a front elevation view illustrating the connection of the controller, means for providing pressurized fluid, valves and fluid passages of the leg massager;

FIG. 7 is a fragmentary cross-sectional view taken along lines 7-7 of FIG. 1; and

FIG. 8 illustrates the user's wearing of the leg massager.

### DETAILED DESCRIPTION OF THE INVENTION

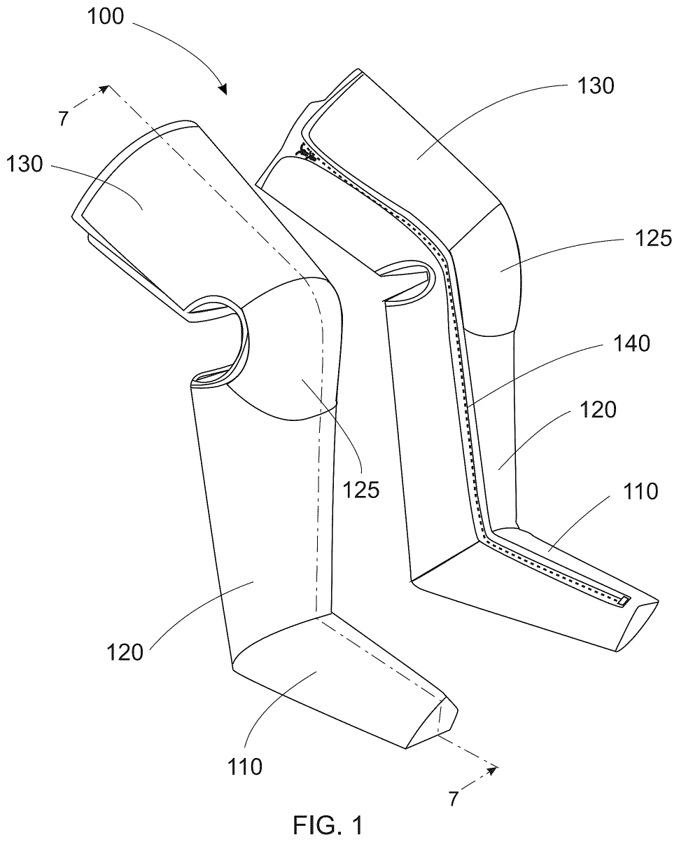

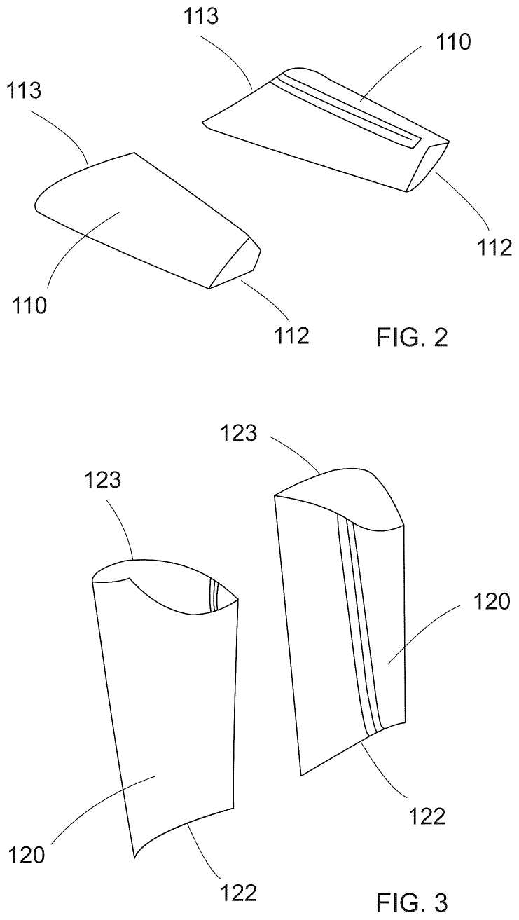

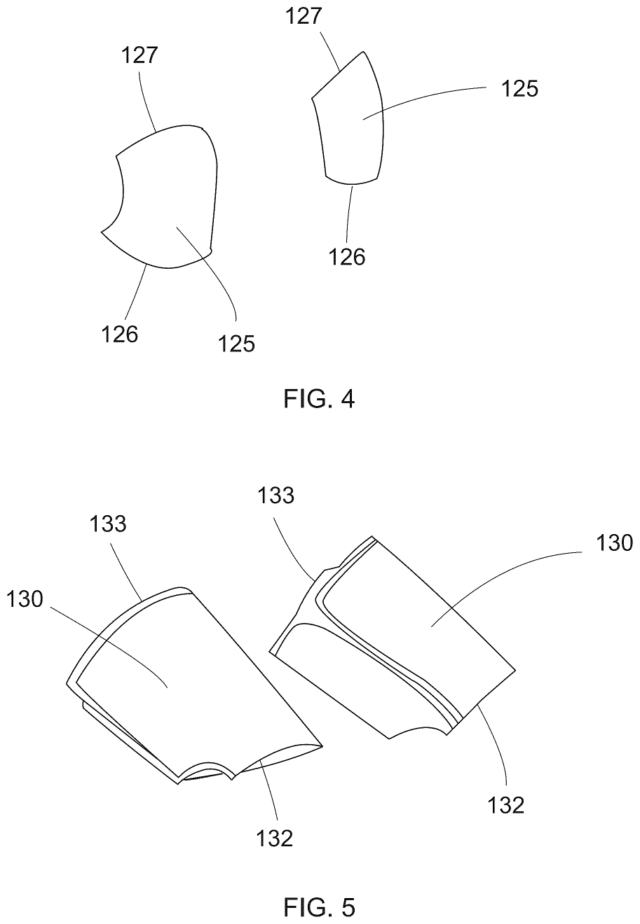

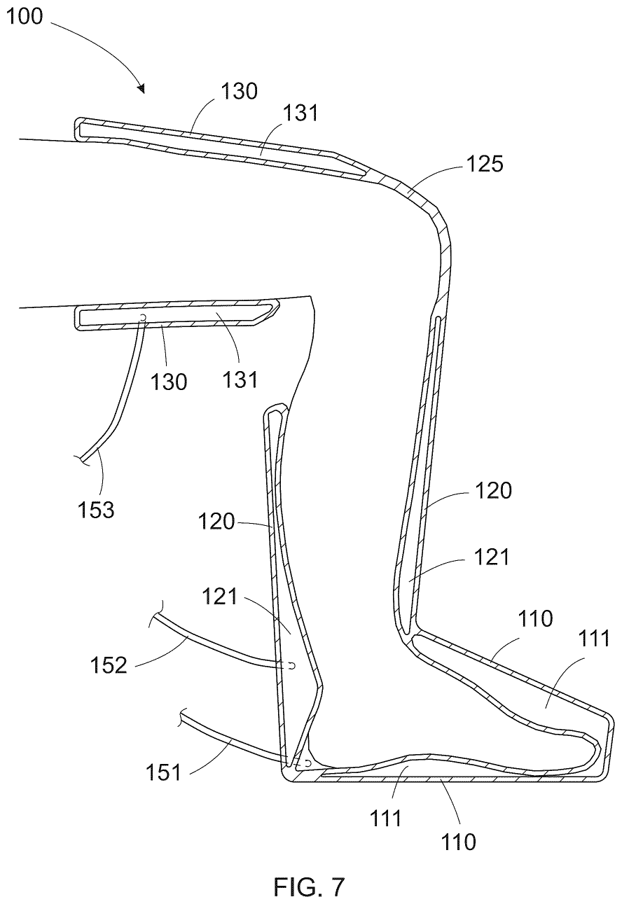

A leg massager is shown in FIGS. 1-7. The leg massager (100) comprises: a flexible foot enclosure (110), having a lower end (112) and an upper end (113), comprising a foot internal volume (111); a flexible calf enclosure (120), having a lower end (122) and an upper end (123), comprising a calf internal volume (121); a flexible knee portion (125), having a lower end (126) and an upper end (127); a flexible thigh enclosure (130), having a lower end (132) and an upper end (133), comprising a thigh internal volume (131).

The leg massager (100) also comprises at least one zipper (140).

The upper end (113) of the foot enclosure connects the lower end (122) of the calf enclosure. The upper end (123) of the calf enclosure connects the lower end (125) of the knee portion. The upper end (126) of the knee portion connects the lower end (132) of the thigh enclosure.

At least one zipper (140) adapts and runs along the leg massager (100) from the foot enclosure (110) to the thigh enclosure (130) through the calf enclosure (120) and the knee portion (125). Different locations of the zippers (140) accommodate different sizes of the user's leg.

The leg massager (100) further comprises a means for providing pressurized fluid (150); a first fluid passage (151) for supplying and removing fluid between the means for providing pressurized fluid (150) and the foot internal volume (111); a second fluid passage (152) for supplying and removing fluid between the means for providing pressurized fluid (150) and the calf internal volume (121); a third fluid passage (153) for supplying and removing fluid between the means for providing pressurized fluid (150) and the thigh internal volume (131).

The leg massager (100) further comprises: a first valve (154), connected between the means for providing pressurized fluid (150) and the first fluid passage (151) for opening and closing the throw of the fluid into the foot internal volume (111); a second valve (155), connected between the means for providing pressurized fluid (150) and the second fluid passage (152) for opening and closing the throw of the fluid into the calf internal volume (121); a third valve (156), connected between the means for providing pressurized fluid (150) and the third fluid passage (153) for opening and closing the throw of the fluid into the thigh internal volume (131).

The leg massager (100) further comprises a controller (157) configured to control the open and close of the first valve (154), second valve (155) and third valve (156).

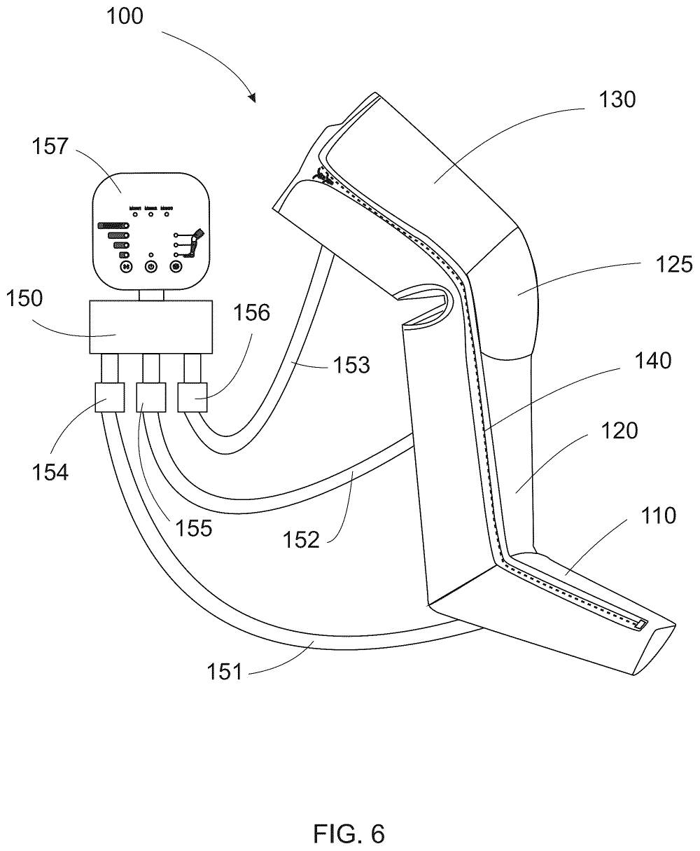

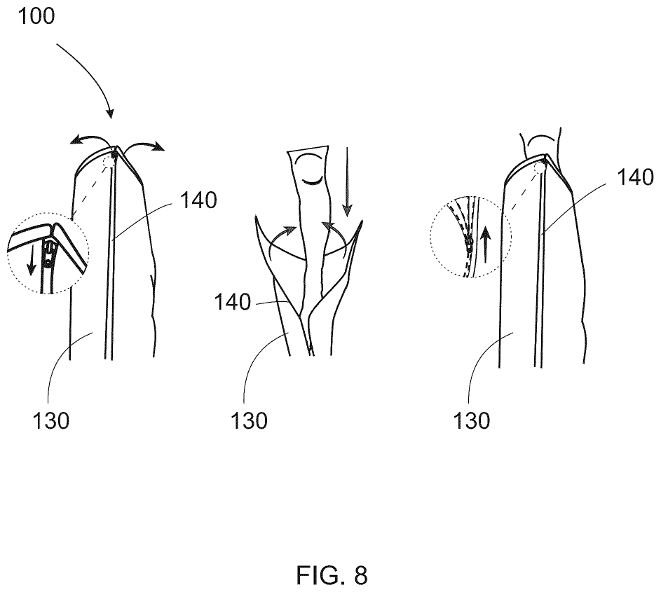

FIG. 8 illustrates the user's wearing of the leg massager (100). The user can use the leg massager (100) easily by opening the at least one zipper (140) down to the foot enclosure (110), inserting a leg into the leg massager (100), closing the at least one zipper (140) along the leg massager (100) from the flexible foot enclosure (110) to the flexible thigh enclosure (130) through the flexible calf enclosure (120) and the flexible knee portion (125). As shown in FIG. 6, The user can use the controller (157) to control the means for providing pressurized fluid (150), the first valve (154), the second valve (155) and the third valve (156) such that compression forces are applied on the user's foot, calf and thigh muscles by flexible foot enclosure (110), flexible calf enclosure (120) and flexible thigh enclosure (130) respectively.

The flexible foot enclosure (110), the flexible calf enclosure (120), the flexible knee portion (125) and the flexible thigh enclosure (130) can be made of flexible sheet material, preferably TPU.

Although the embodiments of the present invention have been shown and described, it will be understood by those skilled in the art that various changes, modifications, substitutions and alterations can be made in these embodiments without departing from the principles and spirit of the present invention. Variations, the scope of the present invention is defined by the claims and their equivalents.

What is claimed is:

1. A leg massager comprising:
a flexible foot enclosure, having a lower end and an upper end, comprising a foot internal volume;
a flexible calf enclosure, having a lower end and an upper end, comprising a calf internal volume;
a flexible knee portion, having a lower end and an upper end;
a flexible thigh enclosure, having a lower end and an upper end, comprising a thigh internal volume;
at least one zipper;
wherein,
the upper end of the foot enclosure connects the lower end of the calf enclosure,
the upper end of the calf enclosure connects the lower end of the knee portion,
the upper end of the knee portion connects the lower end of the thigh enclosure,
at least one zipper adapts and runs along the leg massager from the foot enclosure to the thigh enclosure through the calf enclosure and the knee portion.

2. The leg massager according to claim 1, further comprising:
a means for providing pressurized fluid;
a first fluid passage for supplying and removing fluid between the means for providing pressurized fluid and the foot internal volume;
a second fluid passage for supplying and removing fluid between the means for providing pressurized fluid and the calf internal volume;
a third fluid passage for supplying and removing fluid between the means for providing pressurized fluid and the thigh internal volume.

3. The leg massager according to claim 2, further comprising:
a first valve, connected between the means for providing pressurized fluid and the first fluid passage for opening and closing the throw of the fluid into the foot internal volume;
a second valve, connected between the means for providing pressurized fluid and the second fluid passage for opening and closing the throw of the fluid into the calf internal volume;
a third valve, connected between the means for providing pressurized fluid and the third fluid passage for opening and closing the throw of the fluid into the thigh internal volume.

4. The leg massager according to claim 3, further comprising a controller configured to control the open and close of the first valve, second valve and third valve.
